(19) United States
(12) Patent Application Publication
(10) Pub. No.: US 2026/0158639 A1
(43) Pub. Date: Jun. 11, 2026

(54) TOOL STORAGE SYSTEM TO ACCOMMODATE MULTIPLE DIFFERENT TYPES OF AUTOMOTIVE TOOL KITS

(71) Applicant: Ford Global Technologies, LLC, Dearborn, MI (US)

(72) Inventors: Joel ALONSO VAZQUEZ, Mexico City (MX); Felipe de Jesus SANCHEZ, Nicolas Romero (MX)

(21) Appl. No.: 18/973,322

(22) Filed: Dec. 9, 2024

(51) Int. Cl. B25H 5/00; B60R 11/00; B60R 11/06

(52) U.S. Cl. CPC B25H 5/00; B60R 11/06; B60R 2011/0066

(57) ABSTRACT

A tool storage system for a vehicle may include a frame portion configured to receive a first tool kit and a second tool kit, a first coupling interface to operably couple the first tool kit to the frame portion, and a second coupling interface to operably couple the second tool kit to the frame portion. The first coupling interface and the second coupling interface may utilize a common fastener to operably couple the frame portion to the first tool kit and the second tool kit.

### TECHNICAL FIELD

Example embodiments generally relate to storage systems and, more particularly, relate to a storage system for two distinct types of automotive tool kits.

### BACKGROUND

Different vehicle types and models may require different types of tool kits to best enable vehicle functionality. As such, these tool kits need to be stored and housed within the vehicle conveniently and securely.

Often, a vehicle may require either a tire mobility tool kit or a jack assembly tool kit depending on the vehicle type and its specific vehicle accessories (i.e. tires, rims, etc.). Having different tool kit storage systems for each type of tool kit may underutilize the interior space of the vehicle and may make the respective tool kits difficult to access. Thus, a single tool kit storage system that can securely and conveniently receive either the tire mobility tool kit or the jack assembly tool kit would be desired.

### BRIEF SUMMARY OF SOME EXAMPLES

A tool storage system for a vehicle is provided. The tool storage system may include a frame portion configured to receive a first tool kit and a second tool kit, a first coupling interface to operably couple the first tool kit to the frame portion, and a second coupling interface to operably couple the second tool kit to the frame portion. The first coupling interface and the second coupling interface may utilize a common fastener to operably couple the frame portion to the first tool kit and the second tool kit.

In an example embodiment, a method for configuring a tool storage system to store a selected one of a first tool kit and a second tool kit within a vehicle may be provided. The method may include affixing the tool storage system to a portion of the vehicle. The tool storage system may include a frame portion configured to receive both the first tool kit and the second tool kit, a first coupling interface to operably couple the first tool kit to the frame portion, and a second coupling interface to operably couple the second tool kit to the frame portion. The method may further include positioning the selected one of the first tool kit or the second tool kit on the frame portion, applying a common fastener to the first coupling interface in response to the first tool kit being selected, and applying the common fastener to the second coupling interface in response to the second tool kit being selected.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a tool storage system of a vehicle with a tool kit in accordance with an example embodiment;

FIG. 2 illustrates a perspective view of a tool storage system of a vehicle with a tool kit in accordance with an example embodiment;

FIG. 3 depicts a perspective view of a tool storage system of a vehicle with a tool kit in accordance with an example embodiment;

FIG. 4 illustrates a perspective view of a tool storage system of a vehicle in accordance with an example embodiment;

FIG. 5 depicts a front view of a lug nut of a wheel assembly in accordance with an example embodiment;

FIG. 6 illustrates a side view of a tool storage system of a vehicle in accordance with an example embodiment;

FIG. 7 depicts a back view of a tool storage system of a vehicle in accordance with an example embodiment;

FIG. 8 illustrates a top view of a tool storage system of a vehicle in accordance with an example embodiment;

FIG. 9 depicts a bottom view of a tool storage system of a vehicle in accordance with an example embodiment;

FIG. 10 illustrates a perspective view of a frame portion of a tool storage system of a vehicle in accordance with an example embodiment;

FIG. 11 depicts an exploded view of a tool storage system of a vehicle in accordance with an example embodiment;

FIG. 12 illustrates an exploded view of a tool storage system of a vehicle in accordance with an example embodiment; and

FIG. 13 depicts a perspective view of a wing bolt of a tool storage system of a vehicle in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about,” “approximately” and “substantially,” when used to refer to variability of parameters, should be understood to be definite approximations that account for variations in measurements that cannot be, or as one of skill in the art would appreciate, normally are not, measured precisely. Thus, for example, a parameter that is “about,” “approximately” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide a tool storage system with additional functionality and versatility. Some embodiments may provide for the tool storage system to include a single basic structure that is nevertheless functionally able to receive a variety of different tool kits securely. As a result, a larger number of vehicle types may utilize the tool storage system, thus increasing convenience in vehicle assembly and vehicle customization.

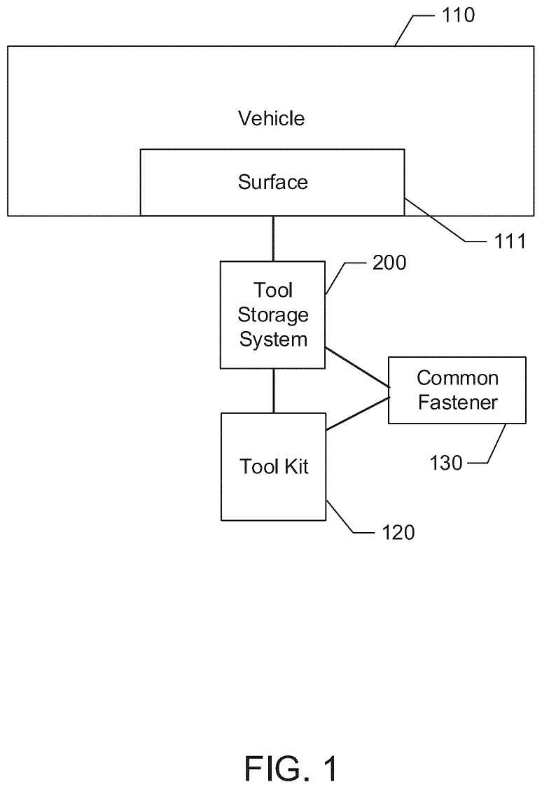

FIG. 1 illustrates a block diagram of a tool storage system of a vehicle in accordance with an example embodiment. As seen in FIG. 1, in some embodiments, the vehicle 110 may include a surface 111, which may be a floor portion of the vehicle 110, an exposed interior surface of the vehicle 110, or a truck bed, trunk, or other storage portion of the vehicle 110. The vehicle 110 may also include a chassis or frame. In some cases, the surface 111 may be operably coupled to the chassis or frame. The chassis or frame may support and may form the foundation structure of the vehicle 110. In an example embodiment, the chassis and frame may be formed of one or more casted or welded metal subframes or may be an unibody construction.

In some cases, a tool storage system 200 may be operably coupled to the surface 111. The tool storage system 200 may be configured to receive and operably couple to a tool kit 120. In an example embodiment, the tool kit 120 may be operably coupled to the tool storage system 200 via a common fastener 130. The common fastener 130 may operably couple a variety of different types and designs of the tool kit 120 to the tool storage system 200.

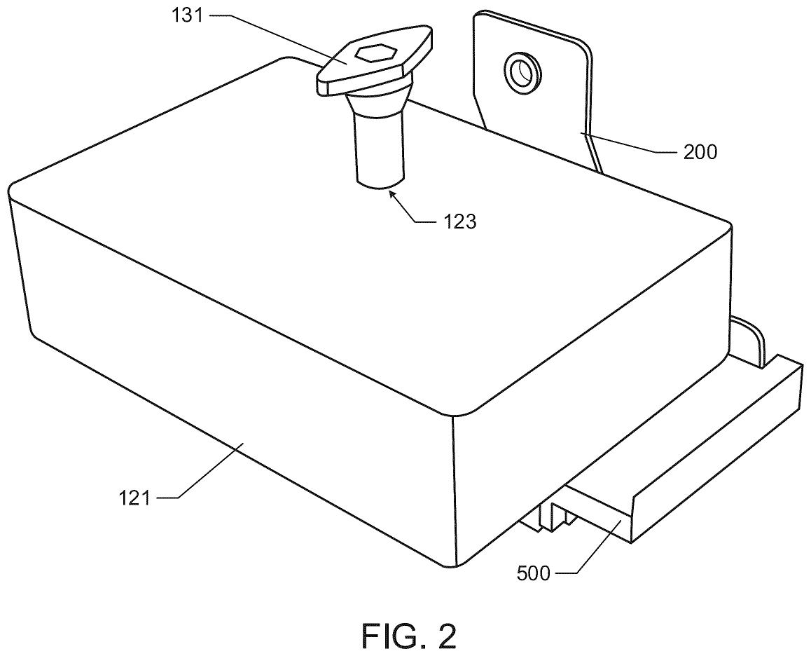

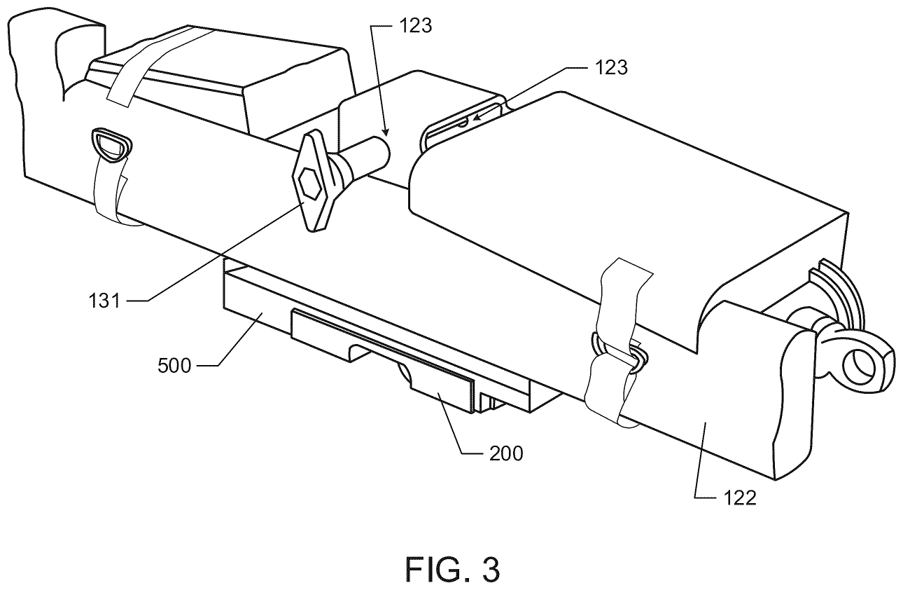

FIG. 2 and FIG. 3 illustrate perspective views of the tool storage system with a tool kit attached. As seen in FIG. 2, the tool kit 120 may be a first tool kit 121, and the first tool kit 121 may be a tire mobility tool kit. As seen in FIG. 3, the tool kit 120 may be a second tool kit 122, and the second tool kit 122 may be a jack assembly tool kit. The first tool kit 121 and the second tool kit 122 may not be limited to the tire mobility tool kit or the jack assembly tool kit, and may be any number of tool kits that a consumer or vehicle operator may desire. The tire mobility tool kit may be a one-piece or two-piece tool kit. The tire mobility tool kit may include a sealing kit to seal a leak in the tire and a compressor to inflate a tire. The jack assembly kit may include a jack assembly (e.g. a scissor jack), handles, wheel chucks, and/or any tools needed to operate the jack assembly for the vehicle 110. In some cases, what is specifically included in the tool kit 120, as well as the type of tool kit 120, may correspond with the model and/or type of the vehicle 110. For example, a tire mobility tool kit may be included for a lighter vehicle where simply patching a tire would be sufficient, and a jack assembly tool kit may be included for heavier vehicles that may need to attach a spare tire to the vehicle 110.

Regardless of using the first tool kit 121 or the second tool kit 122, the tool storage system 200 may secure the first tool kit 121 or the second tool kit 122 via the common fastener 130. In an example embodiment, the common fastener 130 may be a wing bolt 131. The common fastener 130 may not be limited to the wing bolt 131, but may be any number of fastener types that operably couple a variety of types of the tool kit 120 to the tool storage system 200.

The tool storage system 200 may also include a padded insert 500. The padded insert 500 may provide cushioning for the tool kit 120 while operably coupled to the tool storage system 200. The padded insert 500 may be made of foam, rubber, or any number of padded or damping materials. The cushioning and damping provide by the padded insert 500 may limit noise emitted from vibrations of the tool kit 120 within the tool storage system 200 during operation of the vehicle 110, as well as maintain the durability of the tool kit 120. The padded insert 500 may have structural modifications to better accommodate the tool kit 120, such as but not limited to structural features to directly mirror and interact with structures of the tool kit. (i.e. a depression of the padded insert 500 corresponds to a protrusion of the tool kit 120).

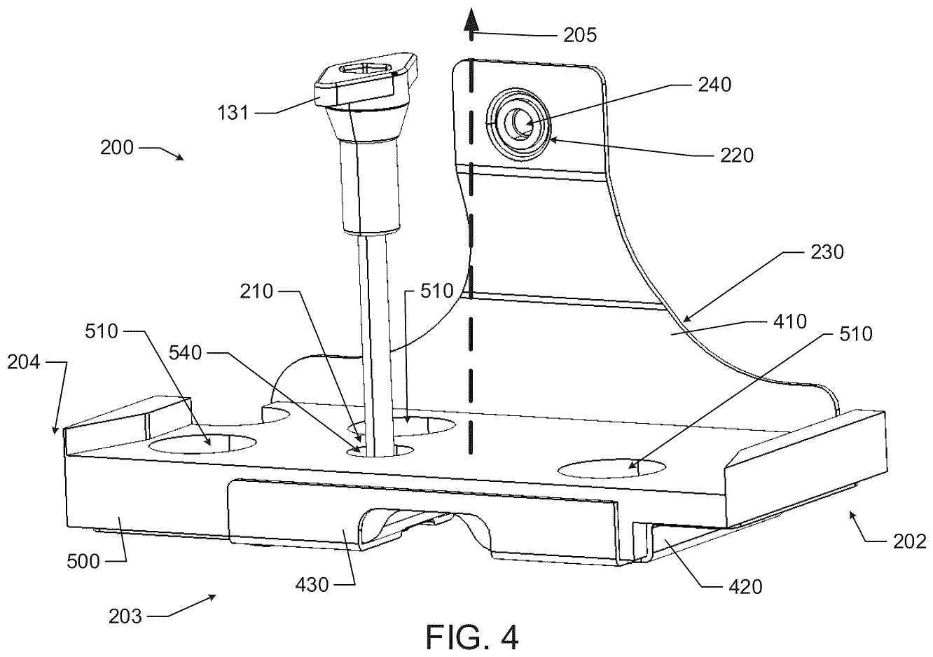

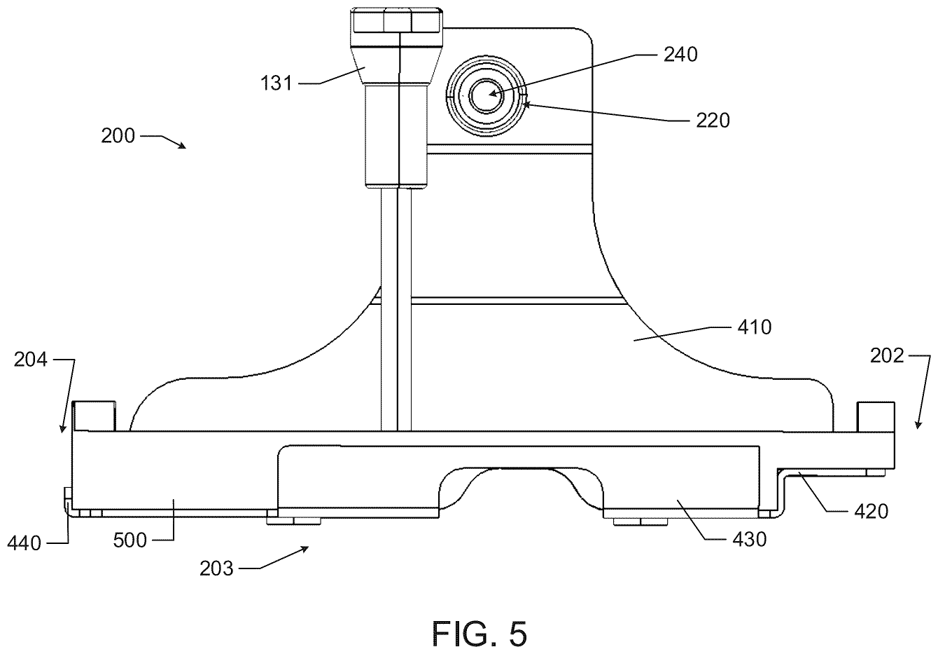

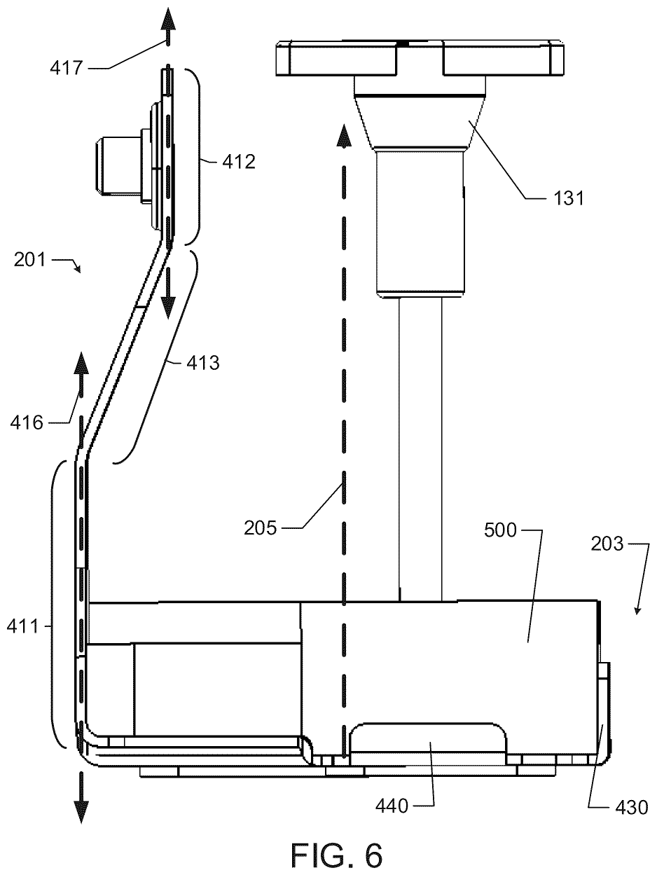

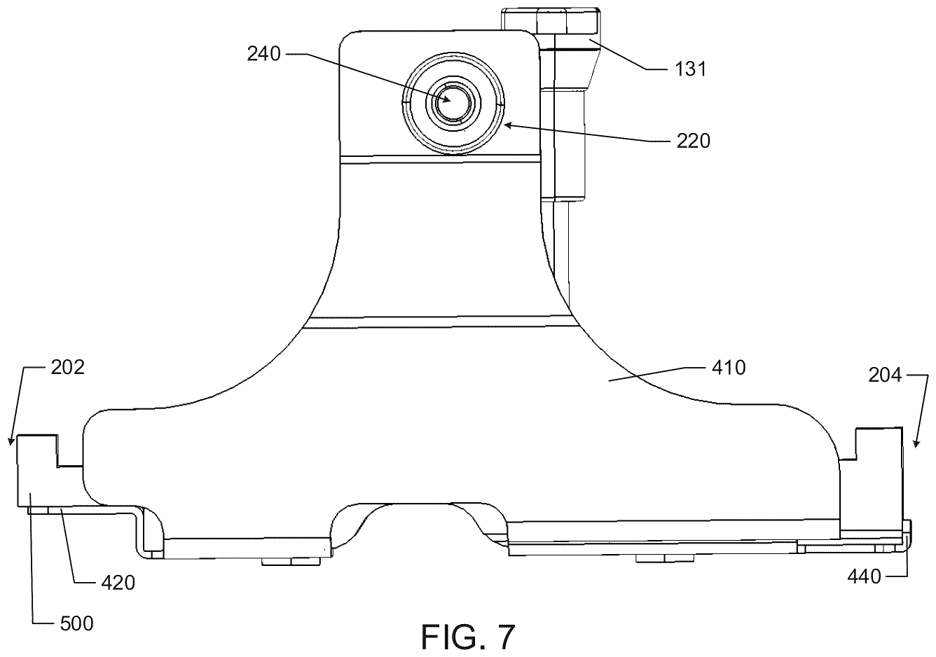

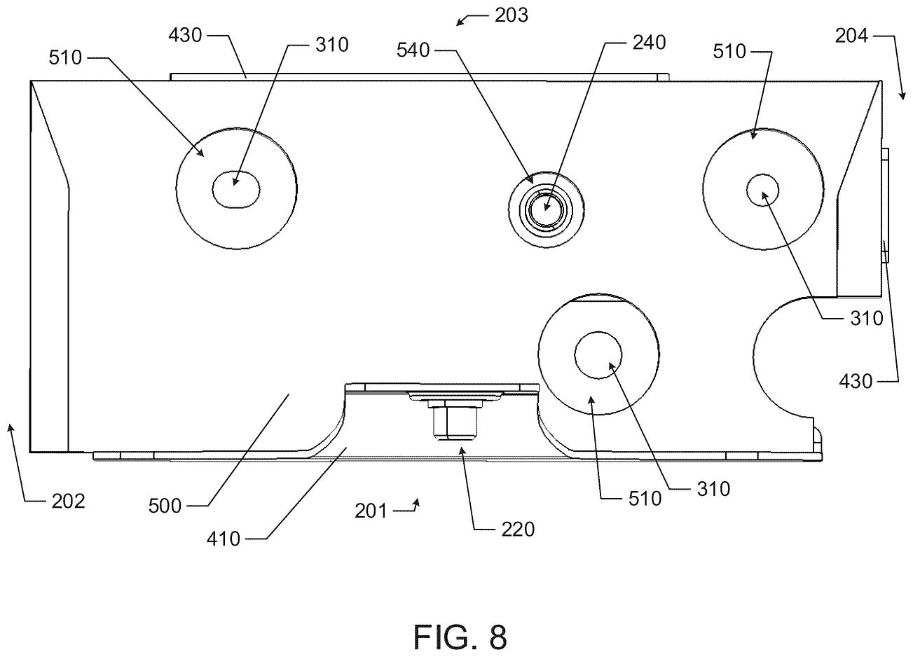

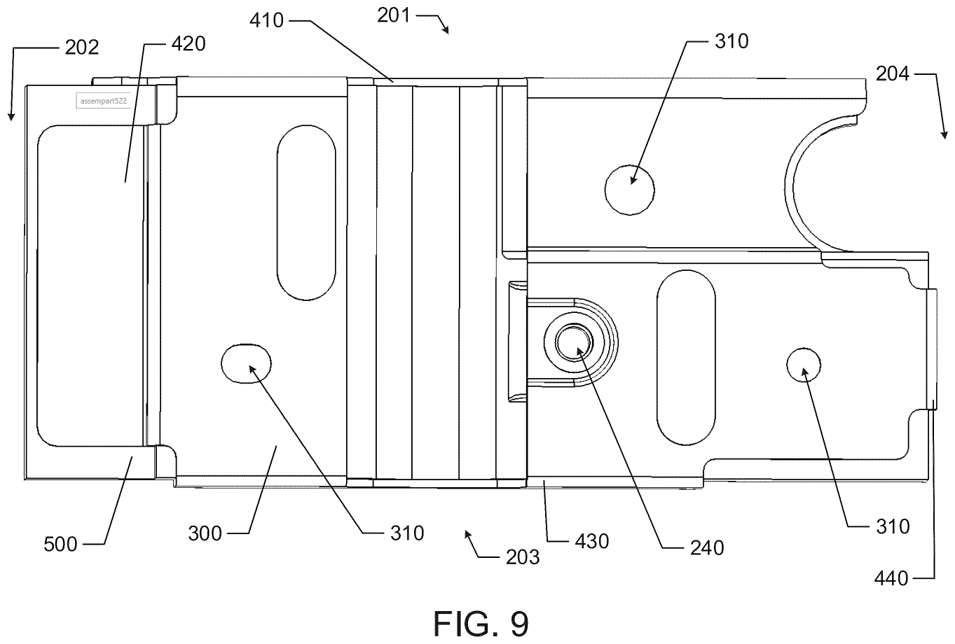

In some cases, the common fastener 130 may extend through a first coupling portion 123 of a first tool kit 121 and a second coupling portion 124 of the second tool kit 122 to operably couple the first tool kit 121 and the second tool kit 122 respectively to the tool storage system 200. FIGS. 4-9 illustrate various views of the tool storage system in isolation without a tool kit actively being stored. As seen in FIGS. 4-9, the tool storage system 200 may include multiple coupling interfaces. For example, the tool storage system 200 may have a first coupling interface 210 for operably coupling the first tool kit 121 to the tool storage system 200 and may have a second coupling interface 220 for operably coupling the second tool kit 122 to the tool storage system 200. In an example embodiment, a frame portion 230 may define the main structure of the tool storage system 200. The frame portion 230 may include the first coupling interface 210 and the second coupling interface 220.

The first coupling interface 210 and the second coupling interface 220 may each further include an instance of a receiving orifice 240. In some cases, the receiving orifice 240 may be disposed on the frame portion 230. The receiving orifice 240 of the first coupling interface 210 and the receiving orifice 240 of the second coupling interface 220 may be disposed orthogonally with respect to one another. In an example embodiment, the receiving orifice 240 may be threaded and may interface with threads on the common fastener 130 to operably couple the tool kit 120 to the tool storage system 200. The receiving orifice 240 may not be limited to threading as its coupling mechanism with the common fastener 130 and may utilize other coupling mechanisms, such a snap-fit assemblies or press-fit mechanisms. In some cases, the tool storage system 200 may utilize a combination of coupling mechanisms to operably couple the common fastener 130 to the receiving orifice 240.

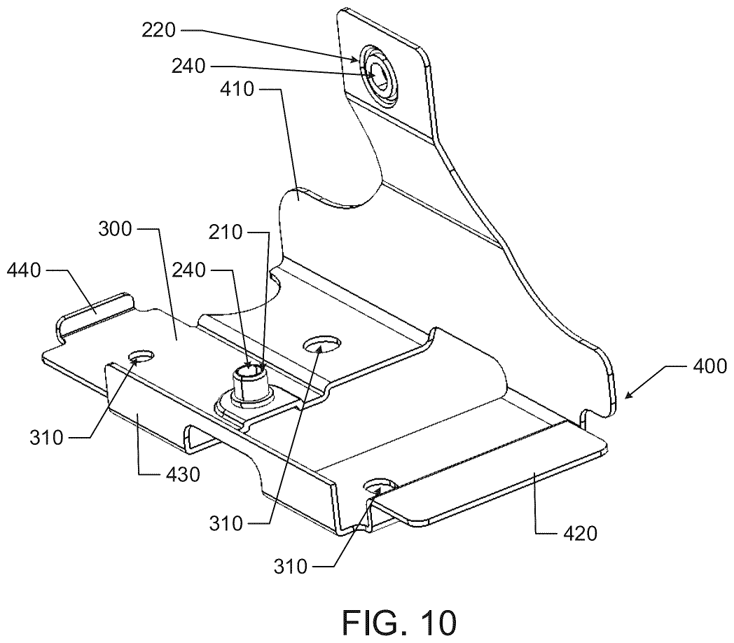

The frame portion 230 of the tool storage system 200 may include a base portion 300 and a retaining portion 400. FIG. 10 illustrates the frame portion in isolation to highlight the structure of the base portion and the shell portion. The base portion 300 may form the base of the tool storage system 200 as a whole. The base portion 300 may be substantially parallel with the surface 111 of the vehicle 110 at a portion of the vehicle 110 where the tool storage system 200 is operably coupled. In some cases, the base portion 300 may include a number of structural modifications to accommodate various features of the surface 111 of the vehicle 110. The structural modifications may include but are not limited to depressions, recesses, and troughs. For example, the surface 111 may be under a seat, and the structural modifications may correspond to the surface structure under the seat.

In some cases, the base portion 300 may include the first coupling interface 210, and thus may include an instance of the receiving orifice 240. The base portion 300 may include a mounting orifice 310. In an example embodiment, the base portion 300 may include multiple instances of the mounting orifice 310. The mounting orifice 310 may receive one or more bolts or other fastener type to operably couple the base portion 300 (and thus the frame portion 230) to the vehicle 110. In some cases, if there are multiple instances of the mounting orifice 310, the multiple instances of the mounting orifice 310 may be evenly distributed and spaced out across the base portion 300.

The retaining portion 400 may include a first retaining portion 410 disposed on a first side 201 of the tool storage system 200, a second retaining portion 420 disposed on a second side 202 of the tool storage system 200, a third retaining portion 430 disposed on a third side 203 of the tool storage system 200, and a fourth retaining portion 440 disposed on a fourth side 204 of the tool storage system 200. In some cases, the first retaining portion 410, the second retaining portion 420, the third retaining portion 430, and the fourth retaining portion 440 all may have different dimensions and shapes. The first retaining portion 410, the second retaining portion 420, the third retaining portion 430, and the fourth retaining portion 440 may extend longitudinally away from the base portion 300. For example, at least some part of the first retaining portion 410, the second retaining portion 420, the third retaining portion 430, and the fourth retaining portion 440 may extend in the same direction as a longitudinal centerline 205 that extends away from a center of the base portion 300 the tool storage system 200.

In an example embodiment, the retaining portion 400 may retain and surround at least a portion of the padded insert 500. The padded insert 500 may be disposed on top of the base portion 300, so that the base portion 300 is disposed between the padded insert 500 and the surface 111 of the vehicle 110. As seen in FIGS. 1 and 2, the first tool kit 121 and the second tool kit 122 may be disposed on top of the padded insert 500, so that the padded insert 500 is disposed between the base portion 300 and the first tool kit 121 or the second tool kit 122.

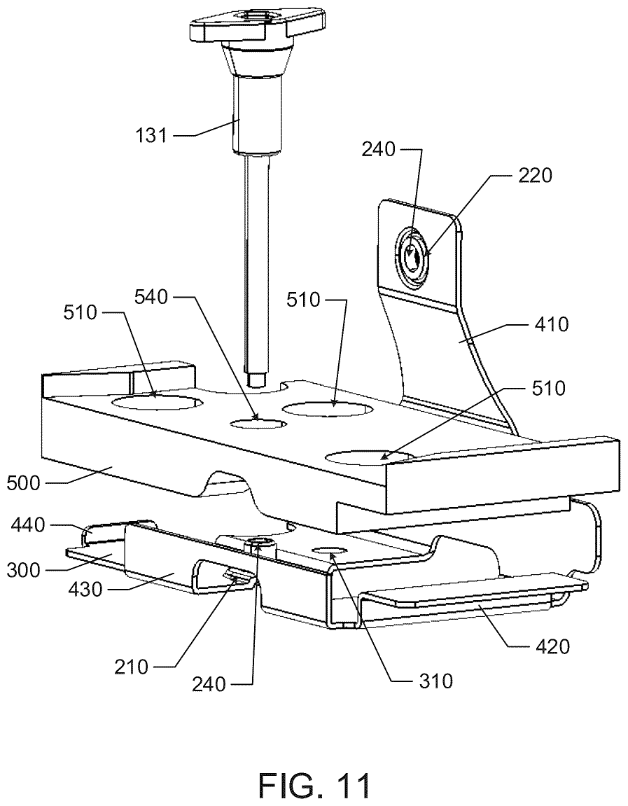

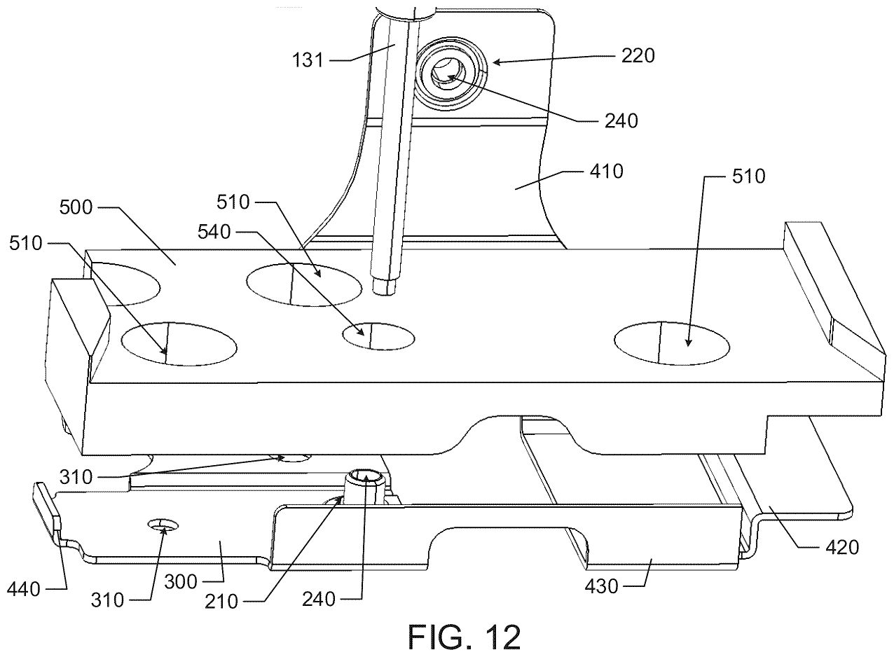

In some cases, the first retaining portion 410, the second retaining portion 420, the third retaining portion 430, and the fourth retaining portion 440 may all be in contact with, provide support for, and/or form a partial perimeter or boundary for the padded insert 500. The padded insert 500 may include a corresponding receiving orifice 540 to the receiving orifice 240 disposed at the base portion 300 and may include multiple instances of a corresponding mounting orifice 510 to the multiple instances of the mounting orifice 310 of the base portion 300. FIGS. 11 and 12 depict exploded views of the tool storage system to further highlight the orientations of the frame portion, the padded insert, and the common fastener (depicted as a wing bolt in these embodiments). As can be seen in FIGS. 11 and 12, the padded insert 500 may generally rest within tool storage system 200 and the base portion 300 and the retaining portion 400 may generally surround the padded insert 500.

In an example embodiment, the first retaining portion 410 may include a number of distinct sections. For example, the first retaining portion 410 may include a first section 411, a second section 412, and a third section 413. In some cases, the first section 411 may be disposed in a first plane 416, and the second section 412 may be disposed in a second plane 417. The first plane 416 and the second plane 417 may be parallel with and offset from one another. Due to the offset, in an example embodiment, the second plane 417 may be disposed closer to the longitudinal centerline 205 than the first plane 416, and the third section 413 may operably couple the first section 411 and the second section 412. In some cases, the third section 413 may be disposed in a third plane not parallel with the first plane 416 and/or the second plane 417. For example, the third plane may be perpendicular with the first plane 416 and the second plane 417.

The first section 411 may operably couple the first retaining portion 410 to the base portion 300. The second section 412 may include the second coupling interface 220. In an example embodiment, the base portion 300 may include the first coupling interface 210, the second section 412 may include the second coupling interface 220, and the first coupling interface 210 and the second coupling interface may be disposed orthogonally or normal to one another.

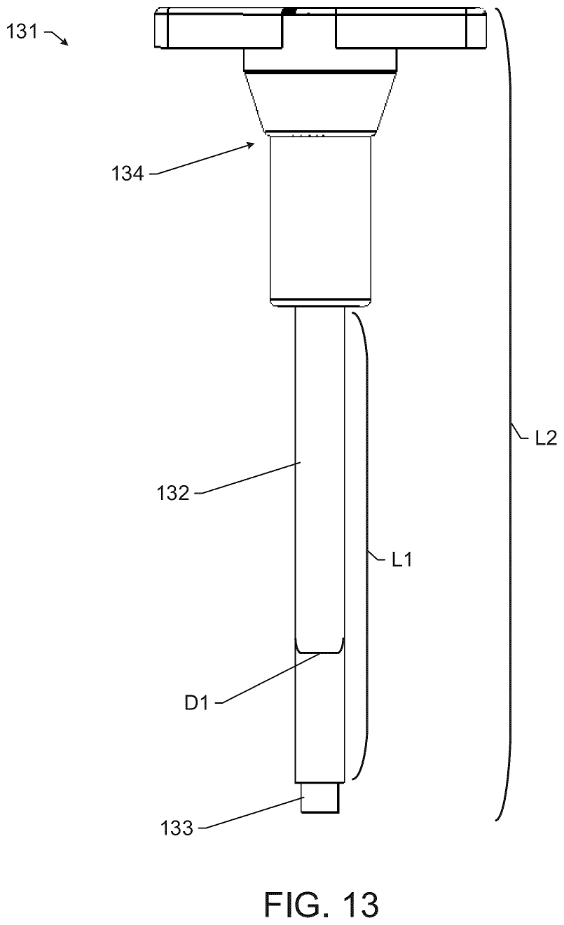

FIG. 13 illustrates a perspective view of the common fastener as the wing bolt in accordance with an example embodiment. In some cases, if the common fastener 130 is the wing bolt 131, the wing bolt 131 may have specific dimensions to ensure operable coupling with various different types of the tool kit 120, including the first tool kit 121 and the second tool kit 122. For example, the wing bolt 131 may need to have a specific diameter and length to couple with the first tool kit 121 and the second tool kit 122. In an example embodiment, the wing bolt 131 may comprise a coupling cylinder 132 to extend through a portion of the first coupling portion 123 and the second coupling portion 124, a coupling end 133 to operably couple with the first coupling interface 210 and the second coupling interface 220, and an operator end 134 to facilitate tightening and loosening of the wing bolt 131. The coupling cylinder 132 may have a first length L1 and a diameter D1. In some cases, the first length L1 may be about 4 mm, and diameter D1 may be about 78.5 mm. Overall, the entirety if the wing bolt 131, including the coupling cylinder 132, the coupling end 133, and the operator end 134, may be defined by a second length L2. In some cases, the second length L2 may be 132.5 mm. The specific length of the second length L2 may be such that the wing bolt 131 does not extend past a maximum dimension or longitudinal extension of the tool storage system 200, so that the wing bolt 131 fits within the footprint and space of the tool storage system 200. In an example embodiment, the operator end 134 may also include a hex interface to assist in the tightening and loosening of the wing bolt 131.

The tool storage system 200 may be disposed and operably coupled to the vehicle 110 in a number of locations. The location where the tool storage system 200 is disposed and operably coupled may correspond to the type of tool kit 120. For example, if the tool kit 120 is a tire mobility kit, the tool storage system 200 may be stored in the trunk or the front of the vehicle 110. If the tool kit 120 is a jack assembly tool kit, the tool storage system 200 may be stored behind or under the seats of the vehicle 110.

A tool storage system for a vehicle may therefore be provided. A tool storage system for a vehicle, the tool storage system may include a frame portion configured to receive a first tool kit and a second tool kit, a first coupling interface to operably couple the first tool kit to the frame portion, and a second coupling interface to operably couple the second tool kit to the frame portion. The first coupling interface and the second coupling interface may utilize a common fastener to operably couple the frame portion to the first tool kit and the second tool kit.

The tool storage system for a vehicle of some embodiments may include additional features, modifications, augmentations and/or the like to achieve further objectives or enhance performance of the lug nut. The additional features, modifications, augmentations and/or the like may be added in any combination with each other. Below is a list of various additional features, modifications, and augmentations that can each be added individually or in any combination with each other. For example, the first coupling interface and the second coupling interface may be disposed orthogonally with respect to one another. In some cases, the first coupling interface and the second coupling interface each may include an instance of a receiving orifice. In an example embodiment, the common fastener may be a wing bolt configured to operable couple with the receiving orifice. In some cases, the wing bolt may extend through a first coupling portion of the first tool kit or a second coupling portion of the second tool kit to operably couple with each instance of the receiving orifice. In an example embodiment, the first tool kit and the second tool kit may include a tire mobility tool kit and a jack assembly tool kit respectively. In some cases, the frame portion may include one or more mounting orifices and the one or more mounting orifices may receive one or more bolts, respectively, to operably couple the frame portion to the vehicle. In an example embodiment, the frame portion may include a base portion and a retaining portion, and the base portion may be substantially parallel with the a surface of the vehicle at a portion of the vehicle where the tool storage system is operably coupled. The retaining portion may be operably coupled to the base portion and may extend longitudinally away from the base portion. In some cases, the retaining portion may include a first retaining portion disposed on a first side of the tool storage system, a second retaining portion disposed on a second side of the tool storage system, a third retaining portion disposed on a third side of the tool storage system, and a fourth retaining portion disposed on a fourth side of the tool storage system, and the first retaining portion, the second retaining portion, the third retaining portion, and the fourth retaining portion may have different dimensions. In an example embodiment, the first retaining portion may include a first section, a second section, and a third section, and the first section may be disposed in a first plane and the second section is disposed in a second plane. The first plane and the second plane may be parallel with and offset from one another, and the third section may operably couple the first section and the second section. In some cases, the second plane may be disposed closer to a longitudinal centerline of the frame portion than the first plane. In an example embodiment, the first section may operably couple to the base portion. In some cases, the second section may include a receiving orifice of the second coupling interface. In an example embodiment, the base portion may include a first receiving orifice of the first coupling interface, and the second section may include a second receiving orifice of the second coupling interface. In some cases, the tool storage system may include a padded insert, and the padded insert may be disposed on top of the base portion and at least partially surrounded by the first retaining portion, the second retaining portion, the third retaining portion, and the fourth retaining portion.

A method for configuring a tool storage system to store a selected one of a first tool kit and a second tool kit within a vehicle may therefore be provided. The method may include affixing the tool storage system to a portion of the vehicle. The tool storage system may include a frame portion configured to receive both the first tool kit and the second tool kit, a first coupling interface to operably couple the first tool kit to the frame portion, and a second coupling interface to operably couple the second tool kit to the frame portion. The method may further include positioning the selected one of the first tool kit or the second tool kit on the frame portion, applying a common fastener to the first coupling interface in response to the first tool kit being selected, and applying the common fastener to the second coupling interface in response to the second tool kit being selected.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to difficulties are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A tool storage system for a vehicle, the tool storage system comprising:
a frame portion configured to receive a first tool kit and a second tool kit;
a first coupling interface to operably couple the first tool kit to the frame portion; and
a second coupling interface to operably couple the second tool kit to the frame portion,
wherein the first coupling interface and the second coupling interface utilize a common fastener to operably couple the frame portion to the first tool kit and the second tool kit.

2. The tool storage system of claim 1, wherein the first coupling interface and the second coupling interface are disposed orthogonally with respect to one another.

3. The tool storage system of claim 1, wherein the first coupling interface and the second coupling interface each further comprise an instance of a receiving orifice.

4. The tool storage system of claim 3, wherein the common fastener is a wing bolt configured to operable couple with the receiving orifice.

5. The tool storage system of claim 4, wherein the wing bolt extends through a first coupling portion of the first tool kit or a second coupling portion of the second tool kit to operably couple with each instance of the receiving orifice.

6. The tool storage system of claim 1, wherein the first tool kit and the second tool kit include a tire mobility tool kit and a jack assembly tool kit, respectively.

7. The tool storage system of claim 1, wherein the frame portion has one or more mounting orifices,
wherein the one or more mounting orifices receive one or more bolts, respectively, to operably couple the frame portion to the vehicle.

8. The tool storage system of claim 1, wherein the frame portion includes a base portion and a retaining portion,
wherein the base portion is substantially parallel with the a surface of the vehicle at a portion of the vehicle where the tool storage system is operably coupled, and
wherein the retaining portion is operably coupled to the base portion and extends longitudinally away from the base portion.

9. The tool storage system of claim 8, wherein the retaining portion has a first retaining portion disposed on a first side of the tool storage system, a second retaining portion disposed on a second side of the tool storage system, a third retaining portion disposed on a third side of the tool storage system, and a fourth retaining portion disposed on a fourth side of the tool storage system, and
wherein the first retaining portion, the second retaining portion, the third retaining portion, and the fourth retaining portion have different dimensions.

10. The tool storage system of claim 9, wherein the first retaining portion includes a first section, a second section, and a third section,
wherein the first section is disposed in a first plane and the second section is disposed in a second plane,
wherein the first plane and the second plane are parallel with and offset from one another, and
wherein the third section operably couples the first section and the second section.

11. The tool storage system of claim 10, wherein the second plane is disposed closer to a longitudinal centerline of the frame portion than the first plane.

12. The tool storage system of claim 10, wherein the first section operably couples to the base portion.

13. The tool storage system of claim 10, wherein the second section includes a receiving orifice of the second coupling interface.

14. The tool storage system of claim 10, wherein the base portion includes a first receiving orifice of the first coupling interface, and the second section includes a second receiving orifice of the second coupling interface.

15. The tool storage system of claim 9, wherein the tool storage system further comprises a padded insert, and
wherein the padded insert is disposed on top of the base portion and at least partially surrounded by the first retaining portion, the second retaining portion, the third retaining portion, and the fourth retaining portion.

16. A method for configuring a tool storage system to store a selected one of a first tool kit and a second tool kit within a vehicle, the method comprising:
affixing the tool storage system to a portion of the vehicle, the tool storage system comprising:
a frame portion configured to receive both the first tool kit and the second tool kit;
a first coupling interface to operably couple the first tool kit to the frame portion; and
a second coupling interface to operably couple the second tool kit to the frame portion,
the method further comprising positioning the selected one of the first tool kit or the second tool kit on the frame portion, applying a common fastener to the first coupling interface in response to the first tool kit being selected, and applying the common fastener to the second coupling interface in response to the second tool kit being selected.

17. The method of claim 16, wherein the first coupling interface and the second coupling interface are disposed orthogonally with respect to one another.

18. The method of claim 16, wherein the first coupling interface and the second coupling interface each further comprise an instance of a receiving orifice.

19. The method of claim 18, wherein the common fastener is a wing bolt configured to operable couple with the receiving orifice.

20. The method of claim 19, wherein the wing bolt extends through a first coupling portion of the first tool kit or a second coupling portion of the second tool kit to operably couple with each instance of the receiving orifice.
